(19) United States
(12) Patent Application Publication
(10) Pub. No.: US 2019/0331019 A1
(43) Pub. Date: Oct. 31, 2019

(54) WATER COOLING DEVICE CAPABLE OF SWITCHING PUMP LOOP

(71) Applicant: JINGWAY TECHNOLOGY CO., LTD., Yun Lin County (TW)

(72) Inventor: Feng-Chang WANG, Yun Lin County (TW)

(21) Appl. No.: 15/965,535

(22) Filed: Apr. 27, 2018

(51) Int. Cl. F01P 7/16; F16K 31/122; F16K 11/044

(52) U.S. Cl. CPC F01P 7/165; F16K 31/122; G06F 1/20; F01P 7/162; F16K 11/044

(57) ABSTRACT

A water cooling device capable of switching a pump loop is provided. The water cooling device sends a liquid coolant through a first pump or a second pump and moves a shuttle valve to a first position or a second position, so that the liquid coolant can flow into the shuttle valve from different directions and then flow out from an output hole. The shuttle check does not consume power, but also can achieve the non-return function. Then, the liquid coolant flows into a water block to cool a load. After that, the liquid coolant flows to a radiator fan for heat dissipation and then flows to the water tank for circulation, achieving the effect of bidirectionally switching the pump loop. The water cooling device can continue to operate without stopping.

### FIELD OF THE INVENTION

The present invention relates to a heat dissipation device, and more particularly to a water cooling device capable of switching a pump loop and running continuously.

### BACKGROUND OF THE INVENTION

Most industrial computers, server computers, and heat-dissipating components are running all day long. The server of the computer generates high heat during operation. Although the computer is installed with a cooling fan, the heat form the computer equipment is continuously generated, and the air convection function of the cooling fan is poor, so the heat dissipation effect is limited. Therefore, in order to effectively reduce the temperature, there is a water cooling device developed by the industry. The water cooling device is installed on the heating element of the electronic device. The continuous circulation of the liquid coolant is used to adjust the operating temperature of the computer server.

However, the conventional water cooling device has a deficiency. Since the conventional water cooling device uses a solenoid valve to prevent the reverse flow of the liquid coolant, the electromagnetic valve is prone to malfunction if it is in a long-term wet state. The water cooling system may be interrupted, which affects the operation of the computer and interrupts the work. Accordingly, the inventor of the present invention has devoted himself based on his many years of practical experiences to solve these problems.

### SUMMARY OF THE INVENTION

The primary object of the present invention is to provide a water cooling device capable of switching a pump loop. The check valve can switch the pump loop, without power consumption, and can maintain the heat dissipation performance all year round.

In order to achieve the aforesaid object, a water cooling device capable of switching a pump loop is provided. The water cooling device comprises a water tank, a first pump, a second pump, a control unit, a shuttle valve, a water block, a radiator fan, a first loop, and a second loop. The water tank has a liquid coolant therein. The first pump has a water inlet connected with a water outlet of the water tank. The second pump has a water inlet connected with the water outlet of the water tank. The control unit is electrically connected to the first pump and the second pump, respectively. The shuttle valve has a main body. The main body has a chamber therein. The chamber includes a first axial hole, a second axial hole and an output hole communicating with one another. The first axial hole is connected with the first pump. The second axial hole is connected with the second pump. The chamber is provided with a check valve. The check valve is movable in the chamber and defines a first position and a second position. When the check valve is in the first position, the first axial hole communicates with the output hole, and the second axial hole doesn't communicate with the first axial hole and the output hole. When the check valve is in the second position, the second axial hole communicates with the output hole, and the first axial hole doesn't communicate with the second axial hole and the output hole. The water block is connected to the output hole of the shuttle valve. The radiator fan has a first end connected to the water block and a second end connected to the water tank. When the check valve is in the first position, the water tank, the first pump, the first axial hole of the shuttle valve, the output hole of the shuttle valve, the water block and the radiator fan communicate with one another to form the first loop. When the check valve is in the second position, the water tank, the second pump, the second axial hole of the shuttle valve, the output hole of the shuttle valve, the water block and the radiator fan communicate with one another to form the second loop.

In the water cooling device capable of switching a pump loop provided by the present invention, the liquid coolant is sent by the first pump or the second pump. The shuttle valve can be moved to the first position or the second position, so that the liquid coolant can flow into the chamber from the first axial hole or the second axial hole and then flow out from the output hole. The shuttle check does not consume power, but also can achieve the non-return function. Then, the liquid coolant flows into a water block to cool a load. After that, the liquid coolant flows to the radiator fan for heat dissipation and then flows to the water tank for circulation, achieving the effect of bidirectionally switching the pump loop. The water cooling device can continue to operate without stopping.

### BRIEF DESCRIPTION OF THE DRAWINGS

FIG. 1 is a configuration diagram of the system of the present invention;

FIG. 2 is a perspective view of the shuttle valve of the present invention;

FIG. 3 is an exploded view of the shuttle valve of the present invention;

FIG. 4 is a sectional view of the shuttle valve of the present invention;

FIG. 5 is a block diagram of the system of the present invention, showing the connection of the first loop;

FIG. 6 is a schematic view of the present invention when in use, showing the liquid coolant flowing into the chamber;

FIG. 7 is a schematic view of the present invention when in use, showing the liquid coolant flowing into the first axial hole;

FIG. 8 is a block diagram of the system of the present invention, showing the connection of the second loop; and

FIG. 9 is a schematic view of the present invention when in use, showing the liquid coolant flowing into the second axial hole.

### DETAILED DESCRIPTION OF THE PREFERRED EMBODIMENTS

Embodiments of the present invention will now be described, by way of example only, with reference to the accompanying drawings.

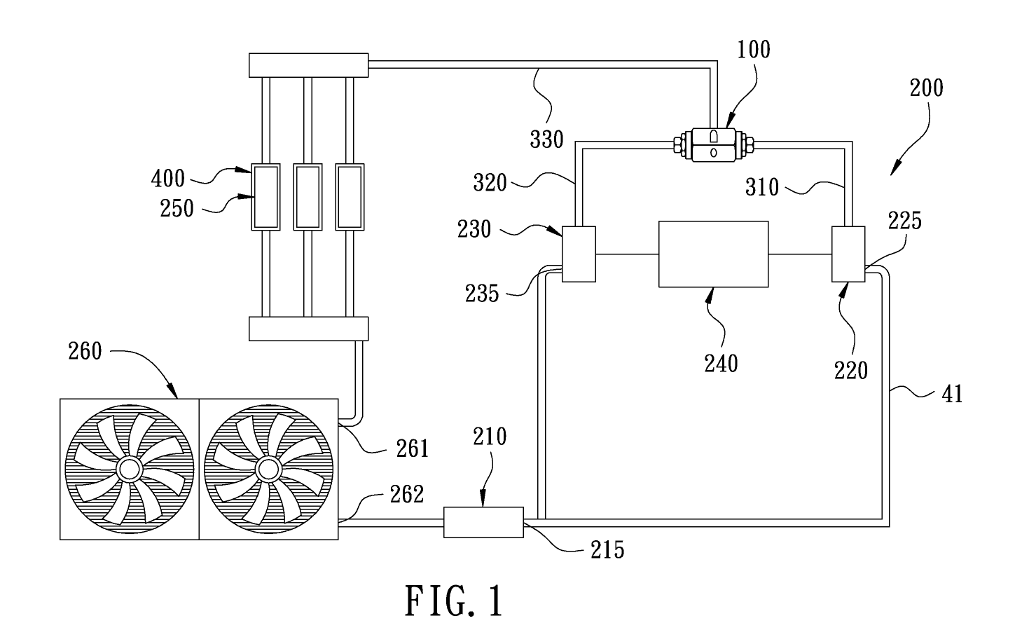

FIG. 1 is a configuration diagram of the system of the present invention. The present invention discloses a water cooling device 200 capable of switching a pump loop, and comprises a water tank 210, a first pump 220, a second pump 230, a control unit 240, a shuttle valve 100, a water block 250, a radiator fan 260, a first loop, and a second loop.

The water tank 210 is provided with a liquid coolant.

The first pump 220 has a water inlet 225 connected with a water outlet 215 of the water tank 210.

The second pump 230 has a water inlet 235 connected with the water outlet 215 of the water tank 210.

The control unit 240 is electrically connected to the first pump 220 and the second pump 230, respectively.

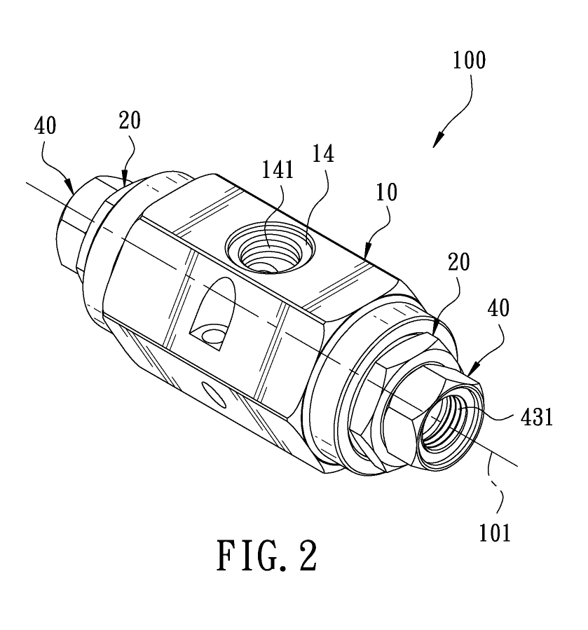

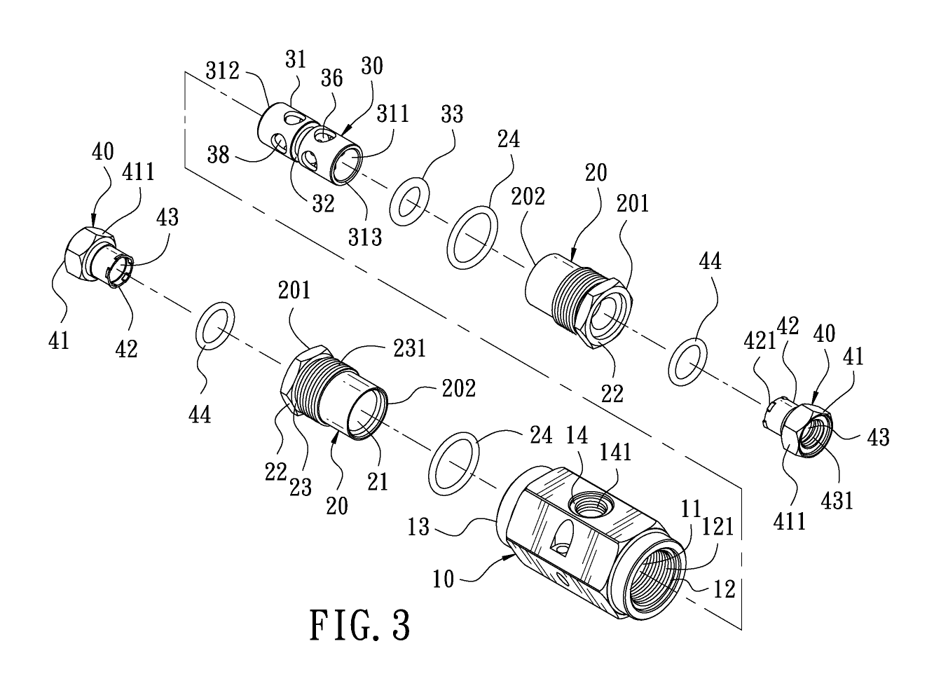

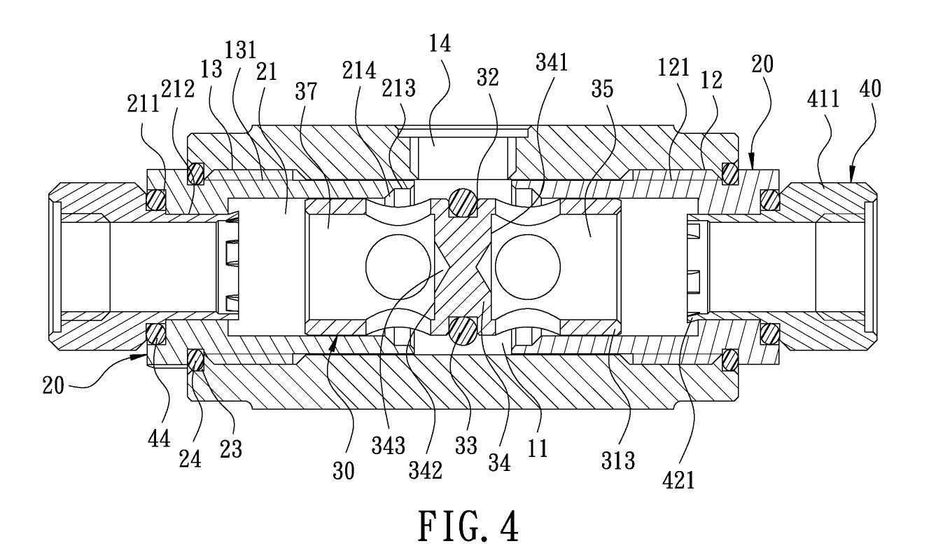

The shuttle valve 100, referring to FIGS. 2-4, comprises a main body 10.

The main body 10 has a chamber 11 therein. The chamber 11 includes a first axial hole 12, a second axial hole 13, and an output hole 14 communicating with one another. The first axial hole 12 and the second axial hole 13 are disposed at two opposite sides of the main body 10, respectively. The central axes of the first axial hole 12 and the second axial hole 13 are located at a same axis 101. The first axial hole 12, the second axial hole 13 and the output hole 14 are provided with internal threads 121, 131, 141, respectively. Each of the first axial hole 12 and the second axial hole 13 is threadedly connected with a positioning plug 20. The positioning plug 20 has a first end 201, a second end 202, and a through hole 21 between the first end 201 and the second end 202. The outer wall of the positioning plug 20 is provided with a stopper 22 at the first end 201. The stopper 22 has an outer diameter greater than respective inner diameters of the first axial hole 12 and the second axial hole 13, so that the stopper 22 can respectively block the first axial hole 12 and the second axial hole 13. The outer wall of the positioning plug 20 is provided with a groove 23 beside the stopper 22. The groove 23 is provided with a sealing ring 24. The outer wall of the positioning plug 20 is provided with an external thread 231 beside the groove 23 so that the positioning plug 20 can be screwed with the internal threads 121, 131 of the first axial hole 12 and the second axial hole 13. The through hole 21 is provided with a stop section 211 at the first end 201. The stop section 211 has an inner diameter greater than that of the through hole 21. The through hole 21 is provided with a limit section 212 beside the stop section 211. The limit section 212 has an inner diameter less than that of the through hole 21. The through hole 21 is provided with a positioning section 213 at the second end 202. The positioning sections 213 of the positioning plugs 20 are spaced from each other. The positioning section 213 has an inner diameter greater than that of the through hole 21. An enlarged section 214 is provided between the positioning section 213 and the through hole 21. The enlarged section 214 has an inner diameter that gradually increases toward the second end 202. In addition, the chamber 11 is provided with a check valve 30. The check valve 30 is disposed between the through holes 21. The check valve 30 has a shuttle member 31. Two ends of the shuttle member 31 have a first opening 311 and a second opening 312 corresponding to the first axial hole 12 and the second axial hole 13. The first opening 311 and the second opening 312 of the shuttle member 31 are provided with damping members 313. In this embodiment, the damping members 313 are end faces at the two ends of the check valve 30. The size of the damping members 313 can be increased by reducing the inner diameters of the first opening 311 and the second opening 312 so as to increase the damping value. The shuttle member 31 is provided with an annular groove 32 on an outer wall of a middle portion thereof. The annular groove 32 is sleeved with a positioning ring 33. The shuttle member 31 is provided with a baffle 34 perpendicular to the axis 101. The baffle 34 has a first surface 341 and a second surface 342 corresponding to the first axial hole 12 and the second axial hole 13, respectively. The first surface 341 and the second surface 342 are respectively recessed with a conical groove 343. The check valve 30 has a first passage 35 and three first perforations 36 communicating with the first opening 311 and disposed between the first opening 311 and the first surface 341. The first passage 35 communicates with the output hole 14. The check valve 30 has a second passage 37 and three second perforations 38 communicating with the second opening 312 and disposed between the second opening 312 and the second surface 342. The second passage 37 communicates with the output hole 14. The check valve 30 is movable in the chamber 11 and defines a first position and a second position. When the check valve 30 is in the first position, the positioning ring 33 is positioned at the positioning section 213 of the second axial hole 13, the baffle 34 closes the second passage 37, and the first axial hole 12, the first passage 35 and the output hole 14 communicate with one another. When the check valve 30 is in the second position, the positioning ring 33 is positioned at the positioning section 213 of the first axial hole 12, the baffle 34 closes the first passage 35, and the second axial hole 13, the second passage 37 and the output hole 14 communicate with one another. In addition, the positioning plug 20 is provided with a rotary joint 40. The rotary joint 40 has a first end 41, a second end 42, and a perforation hole 43 between the first end 41 and the second end 42. The first end 41 of the rotary joint 40 is formed with a screw head 411 extending radially outwardly. The screw head 411 protrudes out of the through hole 21 of the positioning plug 20. The screw heads 411 of the positioning plugs 20 are threadedly connected with a first connecting pipe 310 and a second connecting pipe 320, respectively. The other end of the first connecting pipe 310 is connected to the first pump 220, and the other end of the second connecting pipe 320 is connected to the second pump 230. The perforation hole 43 is provided with an internal thread 431 at the first end 41. The rotary joint 40 is further provided with a stop ring 44. The stop ring 44 is accommodated in the stop section 211. The stop ring 44 is interposed between the screw head 411 and the stop member 22. The second end 42 of the rotary joint 44 is located at the limit section 212. An outer wall of the second end 42 is provided with a plurality of spaced protrusions 421. The protrusions 421 of the rotary joint 40 pass through the limit section 212 and are engaged with the through hole 21 so that the rotary joint 40 can be rotated in the limit section 212.

The water block 250 is connected to the output hole 14 through a third connecting pipe 330.

The radiator fan 260 has a first end 261 connected to the water block 250 and a second end 262 connected to the water tank 210.

When the check valve 30 is in the first position, the water tank 210, the first pump 220, the first axial hole 12 of the shuttle valve 100, the output hole 14 of the shuttle valve 100, the water block 250 and the radiator fan 260 communicate with one another to form the first loop.

When the check valve 30 is in the second position, the water tank 210, the second pump 230, the second axial hole 13 of the shuttle valve 100, the output hole 14 of the shuttle valve 100, the water block 250 and the radiator fan 260 communicate with one another to form the second loop.

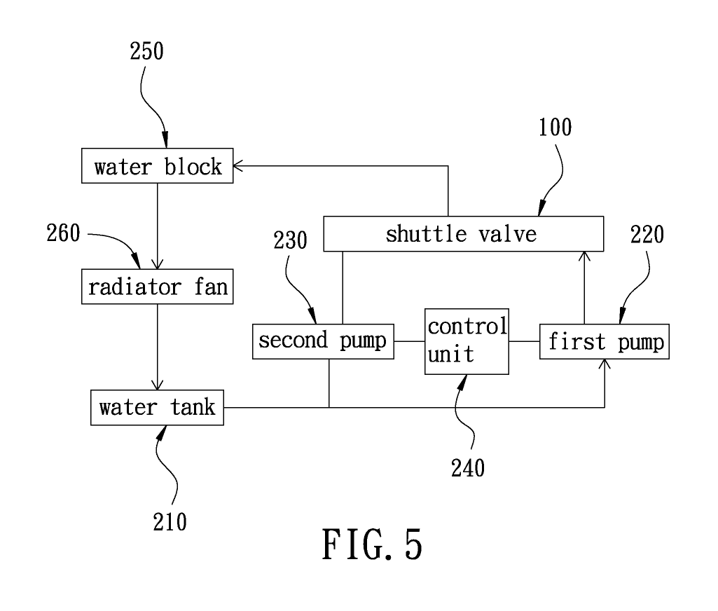

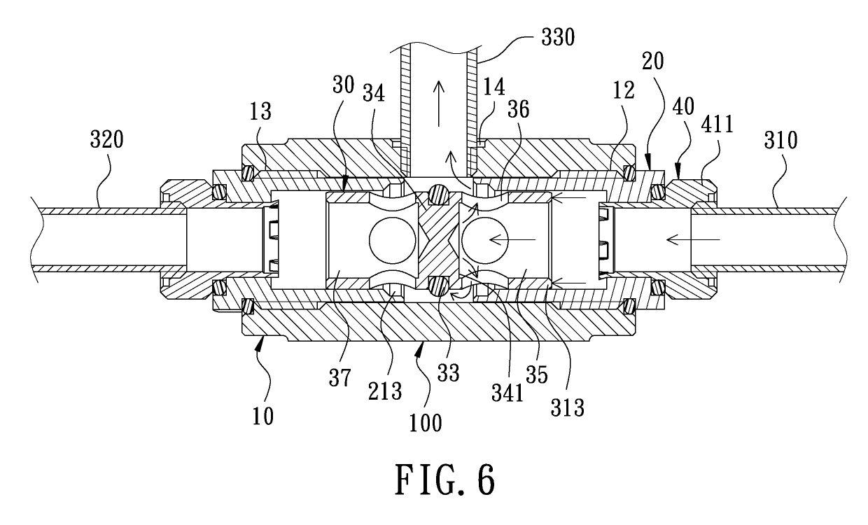

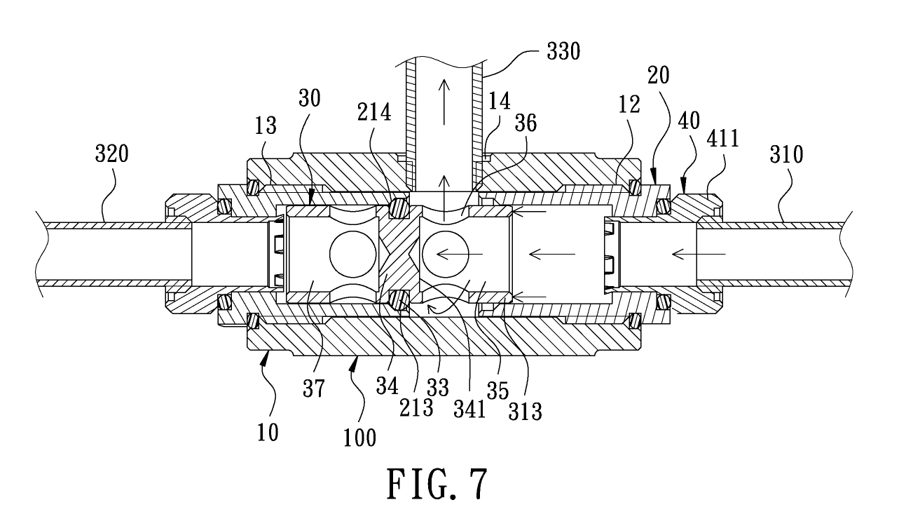

Firstly, the first pump 220 is turned on by the control unit 240. Please refer to FIG. 5, FIG. 6 and FIG. 7, when the first pump 220 is started, the liquid coolant flows from the first pump 220 to the shuttle valve 100. The liquid coolant pushes the baffle 34 of the check valve 30, and the positioning ring 33 is positioned at the positioning section 213 of the second axial hole 13, so that the check valve 30 is located in the first position. Because the inner diameter of the enlarged section 214 is less than the outer diameter of the positioning ring 33, the check valve 30 cannot be moved further. At this time, the baffle 34 closes the second passage 37. The liquid coolant flows in from the first axial hole 12 toward the first surface 341 and then flows through the first perforations 36 to the output hole 14. Then, the liquid coolant flows to the water block 250 to lower the temperature of a load 400. Finally, the liquid coolant flows to the radiator fan 260 to dissipate heat and then flows back to the water tank 210 to form the first loop.

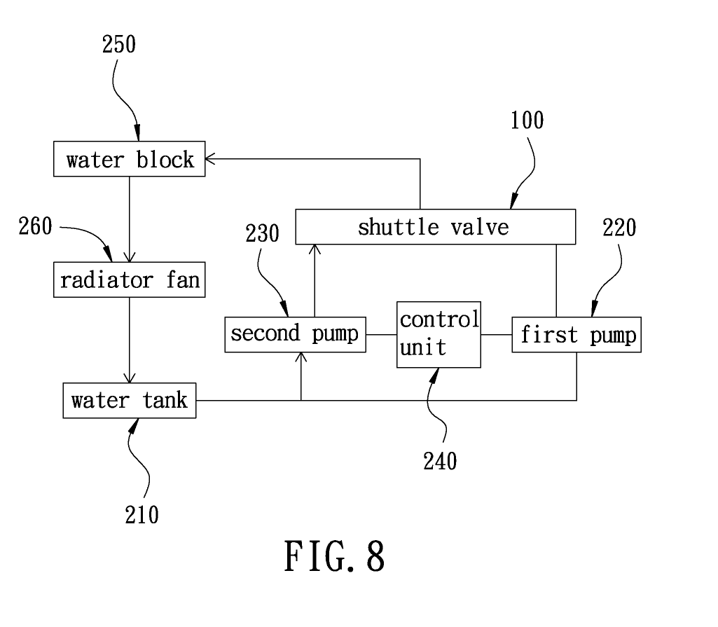

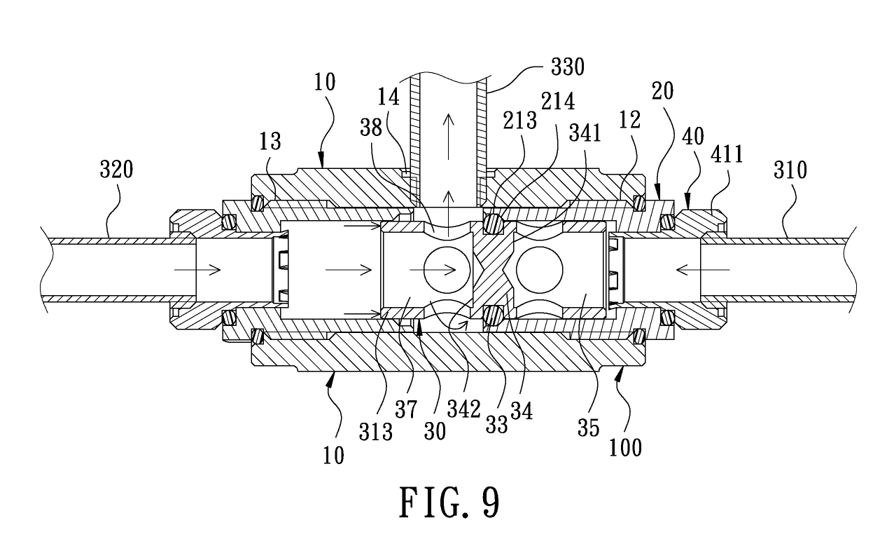

Please refer to FIG. 8 and FIG. 9 again. When the control unit 240 closes the first pump 220 and activates the second pump 230, the liquid coolant flows from the second pump 230 to the shuttle valve 100 to push the baffle 34 to move the check valve 30, and the positioning ring 33 is positioned at the positioning section 213 of the first axial hole 12 so that the check valve 30 is in the second position. The baffle 34 closes the first passage 35. The liquid coolant flows in from the second axial hole 13 toward the second surface 341 and then flows through the second perforations 38 to the output hole 14. Then, the liquid coolant flows to the water block 250 to lower the temperature of the load 400. Finally, the liquid coolant flows to the radiator fan 260 to dissipate heat and then flows back to the water tank 210 to form the second loop. Therefore, the shuttle valve 100 can achieve the non-return function without consuming power. When the first pump 220 or the second pump 230 malfunctions, the other pump can continue to operate to achieve the effect of bidirectionally switching the pump loop, so that the water cooling system requires no downtime and can operate without interruption to achieve the best cooling effect.

When the liquid coolant passes through the first surface 341 or the second surface 342, it may flow along the slope of the conical groove 343 in the direction of the first perforations 36 or the second perforations 38, thereby reducing the turbulence phenomenon and increasing the flow velocity and flow rate of the liquid coolant.

The protrusions 421 of the rotary joint 40 pass through the limit section 212 and are engaged with the through hole 21, so that the rotary joint 40 can be rotated at the limit section 212 to adjust the position of the rotary joint 40 corresponding to the angle of the first connecting pipe 310 and the second connecting pipe 320.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A water cooling device capable of switching a pump loop, comprising:
a water tank, having a liquid coolant therein;
a first pump, having a water inlet connected with a water outlet of the water tank;
a second pump, having a water inlet connected with the water outlet of the water tank;
a control unit, being electrically connected to the first pump and the second pump, respectively;
a shuttle valve, having a main body, the main body having a chamber therein, the chamber including a first axial hole, a second axial hole and an output hole communicating with one another, the first axial hole being connected with the first pump, the second axial hole being connected with the second pump, the chamber being provided with a check valve, the check valve being movable in the chamber and defining a first position and a second position, wherein when the check valve is in the first position, the first axial hole communicates with the output hole, and the second axial hole doesn't communicate with the first axial hole and the output hole; wherein when the check valve is in the second position, the second axial hole communicates with the output hole, and the first axial hole doesn't communicate with the second axial hole and the output hole;
a water block, connected to the output hole of the shuttle valve;
a radiator fan, having a first end connected to the water block and a second end connected to the water tank;
a first loop, wherein when the check valve is in the first position, the water tank, the first pump, the first axial hole of the shuttle valve, the output hole of the shuttle valve, the water block and the radiator fan communicate with one another to form the first loop; and
a second loop, wherein when the check valve is in the second position, the water tank, the second pump, the second axial hole of the shuttle valve, the output hole of the shuttle valve, the water block and the radiator fan communicate with one another to form the second loop.

2. The water cooling device as claimed in claim 1, wherein the check valve has a shuttle member, two ends of the shuttle member have a first opening and a second opening corresponding to the first axial hole and the second axial hole respectively, the shuttle member is provided with a baffle, the baffle has a first surface and a second surface corresponding to the first axial hole and the second axial hole respectively, each of the first surface and the second surface is recessed with a conical groove, the check valve has a first passage and at least one first perforation communicating with the first opening and disposed between the first opening and the first surface, the first passage communicates with the output hole, the check valve has a second passage and at least one second perforation communicating with the second opening and disposed between the second opening and the second surface, the second passage communicates with the output hole, the check valve has a length less than that of the main body, when the check valve is in the first position, the baffle closes the second passage, and the first axial hole, the first passage and the output hole communicate with one another; when the check valve is in the second position, the baffle closes the first passage, and the second axial hole, the second passage and the output hole communicate with one another.

3. The water cooling device as claimed in claim 2, wherein the first axial hole and the second axial hole have internal threads respectively, each of the first axial hole and the second axial hole is threadedly connected with a positioning plug, the positioning plug has a first end, a second end and a through hole between the first end and the second end, an outer wall of the positioning plug is provided with a stopper at the first end, the stopper has an outer diameter greater than inner diameters of the first axial hole and the second axial hole, so that the stopper can block the first axial hole and the second axial hole, the outer wall of the positioning plug is provided with a groove beside the stopper, the outer wall of the positioning plug is provided with an external thread beside the groove so that the positioning plug can be screwed with the internal threads of the first axial hole and the second axial hole, the groove is provided with a sealing ring, the through hole is provided with a stop section at the first end, the stop section has an inner diameter greater than that of the through hole, the through hole is provided with a limit section beside the stop section, the limit section has an inner diameter less than that of the through hole, the through hole is provided with a positioning section at the second end, the positioning section has an inner diameter greater than that of the through hole, an enlarged section is provided between the positioning section and the through hole, and the enlarged section has an inner diameter that gradually increases toward the second end.

4. The water cooling device as claimed in claim 3, wherein the through hole of the positioning plug is provided with a rotary joint, the rotary joint has a first end, a second end and a perforation hole between the first end and the second end, the first end of the rotary joint is formed with a screw head extending radially outwardly, the screw head protrudes out of the through hole of the positioning plug, the perforation hole is provided with an internal thread at the first end, the rotary joint is provided with a stop ring, the stop ring is accommodated in the stop section, the stop ring is interposed between the screw head and the stop member, the second end of the rotary joint is located at the limit section, an outer wall of the second end is provided with a plurality of spaced protrusions, and the protrusions of the rotary joint pass through the limit section and are engaged with the through hole so that the rotary joint can be rotated in the limit section.

5. The water cooling device as claimed in claim 3, wherein the shuttle member is provided with an annular groove, the annular groove is sleeved with a positioning ring, the positioning ring has an outer diameter less than the inner diameter of the positioning section, and the outer diameter of the positioning ring is greater than the inner diameter of the enlarged section.

6. The water cooling device as claimed in claim 2, wherein the first opening and the second opening of the shuttle member are provided with damping members, the damping members are end faces of two ends of the check valve, the damping members can be increased in size by reducing inner diameters of the first opening and the second opening so as to increase their damping values.

7. The water cooling device as claimed in claim 2, wherein the first axial hole and the second axial hole are disposed at two opposite sides of the main body respectively, central axes of the first axial hole and the second axial hole are located at a same axis, and the check valve is provided with the baffle perpendicular to the axis.
